(19) United States
(12) Patent Application Publication
(10) Pub. No.: US 2006/0206488 A1
(43) Pub. Date: Sep. 14, 2006

(54) Information transfer

(76) Inventor: David Distasio, Mount Vernon, NY (US)

Correspondence Address: THE LAW OFFICES OF STEVEN MCHUGH, LLC, 46 WASHINGTON STREET, MIDDLETOWN, CT, 06457, US

(21) Appl. No.: 11/076,347

(22) Filed: Mar. 9, 2005

(51) Int. Cl. G06F 17/30

(52) U.S. Cl. 707/10

(57) ABSTRACT

A method for facilitating the transfer of information between multiple parties provided, wherein the method includes obtaining characteristic information responsive to an information seeker, receiving a query from the information seeker, processing the query from the information seeker to generate an information supplier list responsive to a predetermined algorithm, associating the information seeker with one of the information suppliers on the information supplier list, monitoring communications between the information seeker and the information supplier to generate transaction data and storing the transaction data.

### FIELD OF THE INVENTION

This disclosure relates generally to the transfer of information between multiple parties and more particularly to a method for identifying and associating an information seeker with an information supplier.

### BACKGROUND OF THE INVENTION

With the advent of the personal computer and the World Wide Web (WWW) more information is available to the average person or business now than at any other time in history. In fact, at first glance it would appear that the amount of information resources available would aid in helping individuals and businesses obtain information and/or obtain contacts that could supply desired information. Unfortunately even though an almost unlimited supply of information is right at the proverbial finger tips of an information seeker, locating an information supplier that is able and willing to supply desired information in a consistent and reliable manner is still not an easy task. One reason for this is that the current methods for identifying information suppliers, such as performing keyword searches on the internet, typically returns an extremely large number of possible information sources. This is because the current search engines and other means for gathering and transferring information between parties are unable to parse or separate pertinent information from extraneous information. Thus, the information seeker must manually separate acceptable information sources from unacceptable information sources and depending upon the amount of possible information sources found, this may be an over whelming or even impossible task. As a result, the internet is an inadequate conduit for connecting the information seeker with the information supplier.

For example, a typical internet search engine, such as YAHOO® and GOOGLE™, uses various means to determine the relevance of a user-defined search term to the information retrieved. One way this may be accomplished includes having an interface with a search window where a user can enter an alphanumeric search expression or keyword(s). The search engine software sifts through the index of web pages to locate the pages that have key word identifiers that match the user's search term(s). The search engine then returns the search results in the form of HTML pages displayed as a list of individual entries that have been identified by the search engine as satisfying the user's search expression. Each entry or “hit” includes a hyperlink that points to a Uniform Resource Locator (URL) location or web page (for example, a YAHOO® search for the terms “Small Business Accountant” returned a total of nine hundred thirty two URL's). At this point, the information seeker must weed out the hits that appear to satisfy his or her information requirements.

This problem of excessive information occurs because the search engine is faced with the challenge of matching URL and web page information to a keyword or information profile provided by the information seeker. As such, in most cases, the search engine returns an over-abundance of search-results making the dissemination of valid web sites from invalid web sites impossible or cost prohibitive. For example, a GOOGLE™ search for the term “carburetor” identified and returned over five hundred thousand web pages that identified itself with the key word “carburetor”. An individual or business looking for information suppliers relating to carburetors would have to sift through each of the resultant web pages to determine which information supplier best fits their requirements. Another problem occurs in that text-based, or key word, matching alone often misses some pages that may be relevant to the search of the individual or business. Thus, the information seeker typically ends up getting either too much information or not enough information.

Although there are resources available to assist in associating information suppliers with information seekers, these resources are highly inadequate and still require an excessive amount of filtering to filter out the relevant data from the irrelevant data. For example, “Harvest” is a program that indexes web sites rather than copying its entire contents. Using Harvest, a web site can automatically produce a concise representation, or snapshot, of the information on its site which may then be provided to interested information seekers. Unfortunately, the information seeker must still sift through the found information suppliers. Another example involves a product called “The Grand Central Station” project or GCS. GCS combines both information discovery and web casting based information dissemination into a single system. GCS operates by building a profile of an information seeker and informing the information seeker whenever something new and relevant appears on the digital horizon. GCS accomplishes this by constantly gathering, summarizing and updating is information databanks and sending all relevant information to the information seeker based upon the profile of the information seeker.

Unfortunately, GCS had problems of its own. Although GCS was able to keep an information seeker up to date with semi-generic new information, it was inadequate for providing specific information for a specific problem or query. In order to address this problem, GCS developed a learning engine to analyze information that an information seeker accepts and rejects. Based upon this analysis, GCS refines it queries in an attempt to minimize and/or eliminate irrelevant provisions of information transfer. Currently, there are at least two types of information transfer on the internet, “push” and “pull.” A “push” is a one-time query that elicits a large number of results from the information seekers perspective, forcing the information seeker to filter through large amounts of irrelevant information in order to obtain the desired information. On the other hand, a “pull” is a very specific query that may be too specific to ‘pull’ in the desired information. GCS attempts to accomplish this minimization by tailoring its searches to specific information seekers allowing the information seekers to both “pull” and “push” information on the web.

Unfortunately however, even GCS with the learning engine is unable to adequately connect information seekers with information suppliers without an excessive amount of work required by the information seeker.

### SUMMARY OF THE INVENTION

The above discussed deficiencies and other drawbacks are overcome or alleviated by a method for facilitating the transfer of information between multiple parties, wherein the method includes obtaining characteristic information responsive to an information seeker, receiving a query from the information seeker, processing the query from the information seeker to generate an information supplier list responsive to a predetermined algorithm, associating the information seeker with one of the information suppliers on the information supplier list; monitoring communications between the information seeker and the information supplier to generate transaction data and storing the transaction data.

A system for implementing a method of transferring information between multiple parties is also provided, wherein the system includes a requester portal, a supplier portal and a contact system, the contact system having a processing device, a routing device and a storage device, wherein the requester portal and the supplier portal are communicated with the contact system and wherein the contact system is configured to implement a method for facilitating an information transfer between multiple parties, wherein the method includes obtaining characteristic information responsive to an information seeker, receiving a query from the information seeker, processing the query from the information seeker to generate an information supplier list responsive to a predetermined algorithm, associating the information seeker with one of the information suppliers on the information supplier list, monitoring communications between the information seeker and the information supplier to generate transaction data and storing the transaction data.

A machine-readable computer program code is provided wherein the program code includes instructions for causing a controller to implement a method for transferring information between multiple parties, wherein the method includes obtaining characteristic information responsive to an information seeker, receiving a query from the information seeker, processing the query from the information seeker to generate an information supplier list responsive to a predetermined algorithm, associating the information seeker with one of the information suppliers on the information supplier list, monitoring communications between the information seeker and the information supplier to generate transaction data and storing the transaction data.

The above discussed and other features and advantages of the present invention will be appreciated and understood by those skilled in the art from the following detailed description and drawings.

### BRIEF DESCRIPTION OF DRAWINGS

The foregoing and other features and advantages of the present invention will be more fully understood from the following detailed description of illustrative embodiments, taken in conjunction with the accompanying drawings in which like elements are numbered alike:

FIG. 1 is a block diagram illustrating a system for implementing a method for facilitating the transfer of information;

FIG. 2 is a top level block diagram illustrating an overall method for facilitating the transfer of information;

FIG. 3 is a lower level block diagram illustrating the overall method for facilitating the transfer of information of FIG. 2;

FIG. 4 is a block diagram illustrating a method for receiving a request from an information seeker for the method of FIG. 2;

FIG. 5 is a block diagram illustrating a method for facilitating the transfer of information for the method of FIG. 2;

FIG. 6 is a block diagram illustrating a method for routing an information request to an information supplier for the method of FIG. 2;

FIG. 7 is a block diagram illustrating a method for completing the information transfer transaction for the method of FIG. 2;

FIG. 8 is a block diagram illustrating a method for obtaining feedback for the method of FIG. 2; and

FIG. 9 is a block diagram illustrating a method for processing the information transfer transaction for the method of FIG. 2.

### DETAILED DESCRIPTION OF THE INVENTION

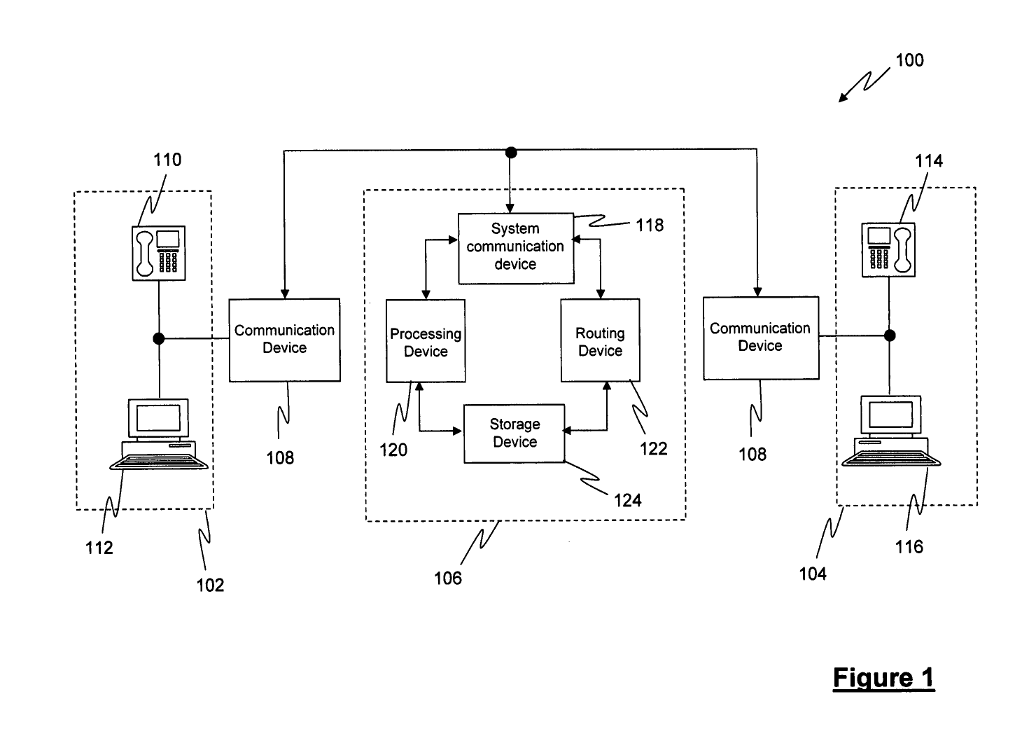

Referring to FIG. 1, an information transfer system (ITS) 100 for implementing a method for transferring information is shown and includes a requester portal 102 and a supplier portal 104 each of which are communicated with a contact system 106 via a communication device 108. Requester portal 102 includes at least one of a requester telephony device 110 and a requester processing device 112. Similarly, supplier portal 104 includes at least one of a supplier telephony device 114 and a supplier processing device 116. Contact system 106 includes a system communication device 118, a system processing device 120, a system routing device 122 and a system storage device 124.

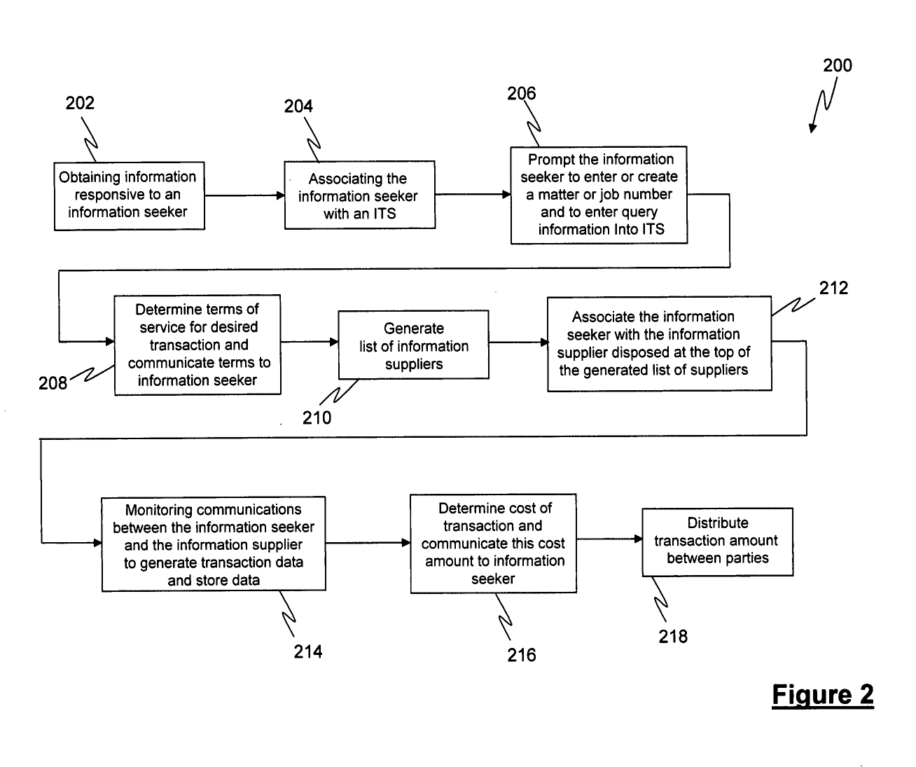

Referring to FIG. 2, a block diagram describing a general overall method 200 for transferring information is shown and includes establishing a relationship with an information seeker and obtaining information responsive to the information seeker, as shown in block 202, and associating the information seeker with an ITS 100, as shown in block 204. This may be accomplished by the information seeker establishing a connection with the transfer system 100 via a requester portal 102 having a communication device such as a telephone 110 and/or a processing device 112. The information seeker logs into the ITS 100, via requester portal 102, by entering a predetermined user account number. If the ITS 100 determines that the user account number is invalid or does not exist, then the ITS 100 informs the information seeker of that fact and queries the information seeker to determine if the information seeker wants to open an account. If the information seeker does not want to open an account, the ITS 100 terminates the communication between the information seeker and the ITS 100. However, if the information seeker does want to open an account or does want to reactivate an existing expired account, then the ITS 100 prompts the information seeker to enter information required to open an account, such as personal information and/or billing information. Once all of the required information has been communicated to the ITS 100, then the user account is activated. At this point, the information seeker logs into the ITS 100 by entering his/her assigned account number into the ITS 100.

At this point, the ITS 100 prompts the information seeker to enter or create a matter or job number and to enter query information into ITS 100, as shown in block 206. The matter or job number may be used to identify all transactions related to a specific action and/or a specific information request. Depending on the membership level of the information seeker, the information seeker may request a specific supplier or the information seeker may request that the ITS 100 determine an appropriate information supplier. Using the information seekers membership information and the information entered by the information seeker, the ITS 100 determines the terms of service for the desired transaction and communicates these terms to the information seeker, as shown in block 208. If the information seeker does not agree to the terms of service, then the contact system terminates the connection.

However, if the information seeker does agree to the terms of service, the contact system retrieves routing information and quality control information which may be in whole or in part responsive to the information seeker. At this point, the ITS generates a list of information suppliers, as shown in block 210, wherein the list of information suppliers is responsive to the obtained information, such as the type of information requested, the routing information and the quality control information. This list may be generated, at least in part, using a predetermined algorithm that is at least partially responsive to at least one of the quality control characteristics, the information supplier membership characteristics and the information seeker membership characteristics. Moreover, this list may include contact information and any other information suitable to the desired end purpose, such as specific information supplier information and experience level with the requested technology.

The ITS 100 then attempts to associate the information seeker with the information supplier disposed at the top of the generated list of information suppliers, as shown in block 212. This may be accomplished by communicating the identity of the information supplier selected by the ITS 100 to the information seeker for approval. If the information seeker does not approve of the selected information supplier, the information seeker may request that the ITS 100 provide the next available identified information supplier. However, if the information seeker does approve of the selected information supplier, then the ITS 100 attempts to facilitate the connection between the information seeker and the information supplier via the system routing device 122. Upon approval of an information supplier by the information seeker, the ITS 100 attempts to obtain contact with the information supplier via the routing device 122, the system communication device 128 and the supplier portion 104. It should be appreciated that ITS 100 may also attempt to associate the information seeker with the category of information suppliers based upon predetermined parameters, such as history, information type, payment type, cost type, etc.

It should be appreciated that the information seeker and/or the information supplier each may connect to the ITS 100 using either a telephone 110, 114 and/or a processing device 112, 116. For example, if both the information seeker and the information supplier connect to the ITS 100 via telephone 110, 114, then the information seeker and the information supplier can communicate via a voice link. However, if one of the information seeker and the information supplier connects to the ITS 100 via a processing device, such as a computer, and the other of the information seeker and the information supplier connects to the ITS 100 via the telephone 110, 114, ITS 100 may facilitate the connection by including a capability to convert audio to text and text to audio. It should also be appreciated that the information seeker and the information supplier may communicate for any length of time responsive to the desires of both the information seeker and the information supplier. If the information supplier is unable to provide the desired information to the information seeker, the information seeker has the option of canceling the current transaction and having the contact system connect the information seeker with the information supplier that is next on the generated list.

This process can be repeated until the information seeker obtains all of the information desired. Additionally, if the information seeker has attempted to obtain information from an information supplier during a time when the information supplier is unavailable, the information seeker also has the option of leaving a detailed information request which will be communicated to the information supplier during the information suppliers available hours or the information seeker may request that the ITS 100 provide another information supplier listed on the generated list.

Once the information seeker has been associated with the information supplier, an information exchange takes place between the information supplier and the information seeker. This information exchange, and each transaction, is monitored by ITS 100 and may be recorded by system processing device 120 and stored within system storage device 124 for future retrieval by the information seeker and/or the information supplier, as shown in block 214. When the information seeker has obtained the desired information from the information supplier, the ITS 100 prompts the information seeker to enter in feedback information, as shown in block 216. This feedback information may include quality control characteristic information such as the performance quality of the information supplier, the amount of time required to obtain desired information and quality of the information received. Once the feedback information has been entered by the information seeker, the ITS 100 determines the cost of the transaction and communicates this transaction amount to the information seeker, as shown in block 216. Once the information seeker has paid the transaction amount, the transaction amount may be distributed between the ITS administration and the information suppliers involved in the information exchange, as shown in block 218.

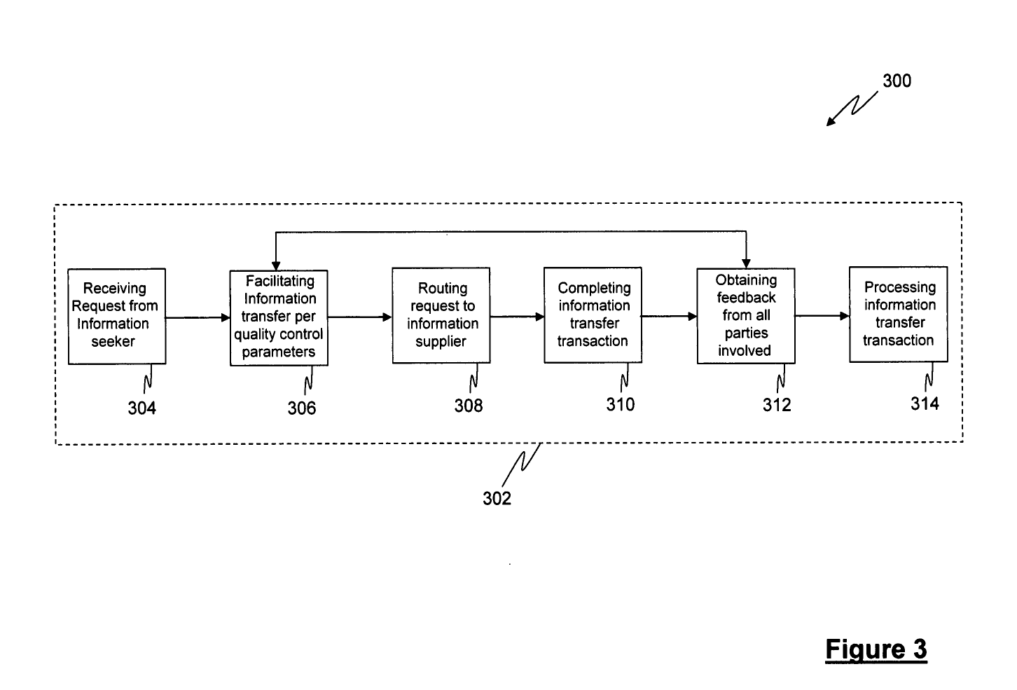

Referring to FIG. 3, a top level block diagram illustrating an overall embodiment of a method 300 for transferring information is shown and includes a plurality of elements 302 including ITS 100 receiving a request from an information seeker, as shown in block 304, facilitating the information transfer responsive to quality control parameters, as shown in block 306, routing the request to an information supplier, as shown in block 308, completing the information transfer transaction, as shown in block 310, obtaining feedback from all parties involved in the information transfer transaction, as shown in block 312, and processing the information transfer transaction, as shown in block 314. Each one of these elements is described in more detail hereinbelow.

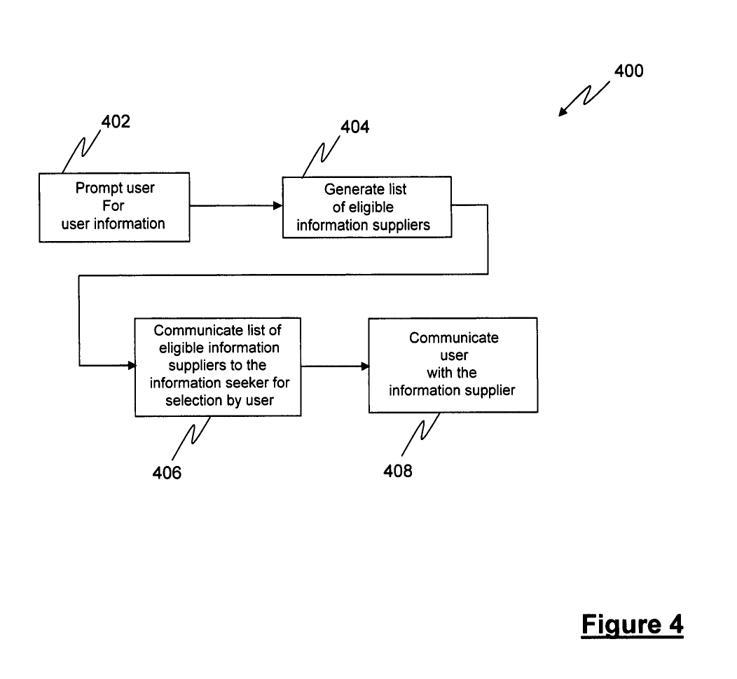

Referring to FIG. 4, a block diagram describing a method 400 for receiving a request from an information seeker is shown and discussed. Once a user sends a request to the network, the user is prompted for user information, as shown in block 402. User information may include, but not be limited to, existing account information, new account information, query information and information supplier requests. Once the network obtains all of the pertinent information from the information seeker, the network generates a list of eligible information suppliers, as shown in block 404. It should be appreciated that this list of eligible information suppliers is at least partially responsive to the obtained user information. The list of eligible information suppliers is then communicated to the user and the user selects which information supplier the user would like to obtain information from, as shown in block 406. It should be appreciated that the user may also leave the information supplier selection up to the network wherein the selection may be based on predetermined conditions as supplied by the user. The network then communicates the user with the information supplier, as shown in block 408. If the information supplier is unavailable at the time of the request, the network will provide the user the option of leaving a message and waiting for the information supplier to respond and/or moving on to another information supplier on the above generated list of information suppliers.

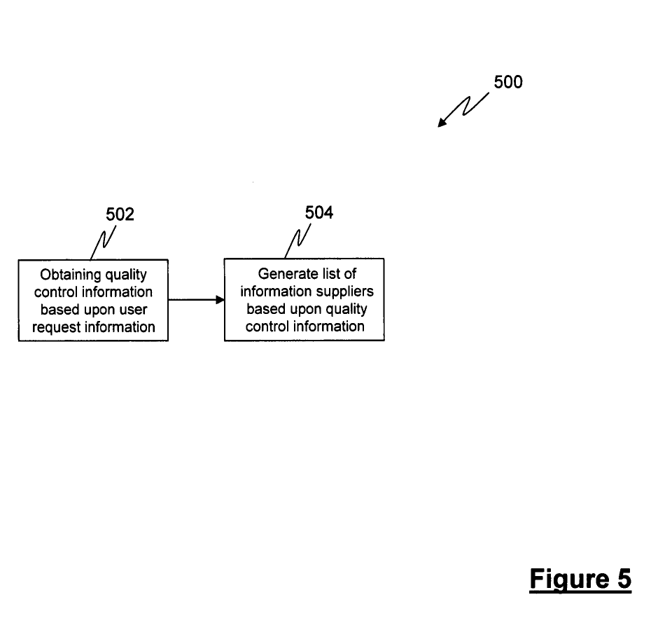

Referring to FIG. 5, a block diagram describing a method 500 for facilitating the information transfer responsive to quality control parameters is shown and includes the network obtaining quality control information responsive to a user requesting information, as shown in block 502. Upon an information request by a user, the network generates a list of information suppliers based, at least in part, upon the obtained quality control information, as shown in block 504. It should be appreciated that the generation of this list may be responsive to many variables, such as prior user/information supplier interaction, information supplier performance history and/or user performance history, location, profession, professional certification(s), language, price, and/or account ID.

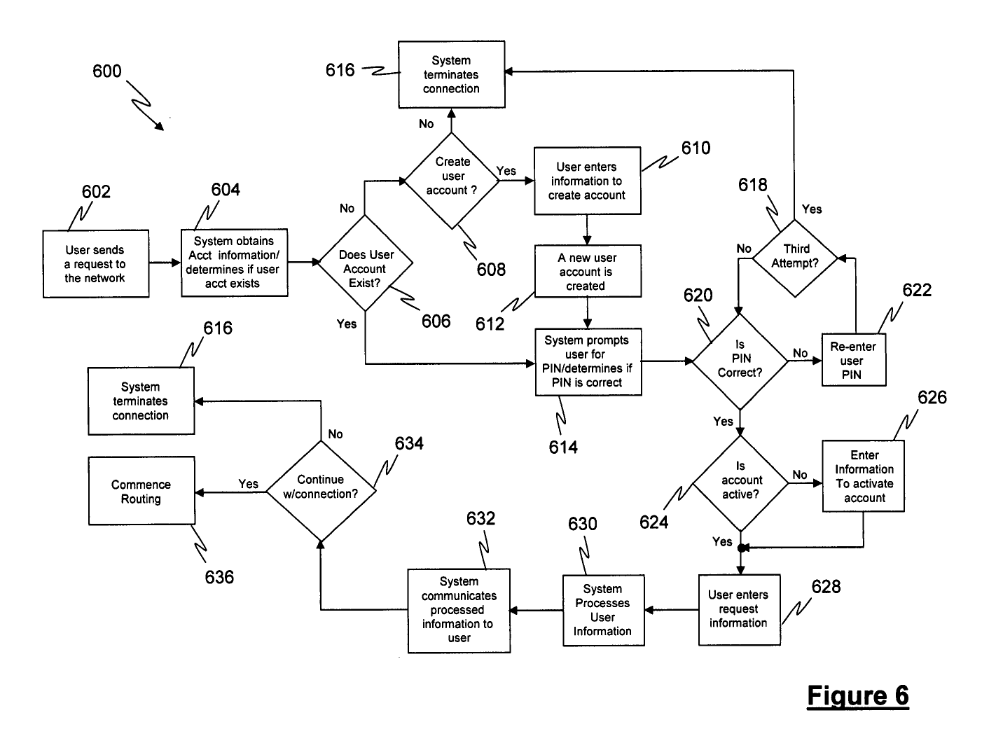

Referring to FIG. 6, a block diagram describing a method 600 for routing an information request to an information supplier is shown and includes an information seeker sending a request and account information to ITS 100 via requestor portal 102, as shown in block 602. ITS 100 receives this information via system communication device 118 and transfers this information to processing device 120. Processing device 120 verifies that the entered information is valid and that the user account being accessed exists, as shown in block 604. ITS 100 will then respond in a manner responsive to whether the user account is valid or not, as shown in block 606. If the user account does not exist and/or is invalid, the ITS 100 prompts the information seeker to create a new user account, as shown in block 608. If the information seeker does not wish to create a new user account, then ITS 100 will terminate the connection, as shown in block 616.

On the other hand, if the information seeker does wish to create a new user account, the information seeker communicates information required to create a new user account to ITS 100 via requester portion 102, as shown in block 610. Once the required information has been communicated to ITS 100, processing device 120 creates a new user account responsive to the information communicated, as shown in block 612. After the user account has been created, the ITS 100 then prompts the information seeker for an identification, or PIN, code, as shown in block 614. In a similar fashion, if the ITS 100 determines that the user account does exist, as shown in block 606, then the ITS 100 prompts the information seeker for an identification, or PIN, code, as shown in block 614. Once the ITS 100 determines that the PIN code is correct, as shown in block 620, ITS 100 may respond in a manner responsive to this determination. For example, if the ITS 100 determines that the PIN code that was entered is incorrect, then ITS may prompt the information seeker to re-enter the PIN code, as shown in block 622. The ITS may also keep track of how many times a PIN code has been entered, as shown in block 618, and if the PIN code has not been entered more than a predetermined limit, the ITS 100 may re-prompt the information seeker to re-enter the PIN code until the predetermined limit has been reached and then the ITS 100 may terminate the connection, as shown in block 616, and/or may disable the account to ensure that the unauthorized access does not occur.

If the ITS 100 determines that the PIN code is correct, as shown in block 620, then the ITS 100 determines if the user account is active, as shown in block 624. If the user account is not active, then the ITS 100 prompts the information seeker to enter information required to activate the account, as shown in block 326. Once the information seeker has entered the information required to activate the user account or if the user account was found to be active by ITS 100 during the determination shown in block 324, then the ITS 100 prompts the information seeker to enter request information to complete the information seeker request, as shown in block 628. Processing device 120 processes the request information, as shown in block 330, to generate connection information, such as billing information, connection information and available information supplier information, and communicates this generated information to the information seeker via system communication device 118, as shown in block 632. The ITS 100 then prompts the information seeker to determine if the information seeker wants to continue with the information transfer responsive to the generated information, as shown in block 634. If the information seeker does not wish to continue with the information transfer, then the ITS 100 terminates the connection, as shown in block 616. However, the information seeker does wish to continue with the information transfer, then ITS 100 begins routing or connecting the information seeker with the information supplier via routing device 122, as shown in block 638.

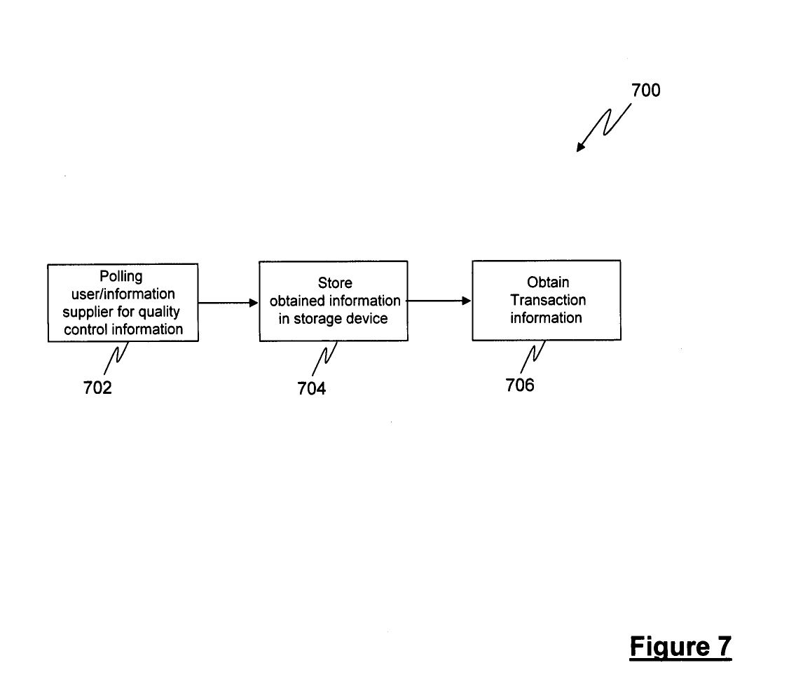

Referring to FIG. 7, a method 700 for completing the information transfer transaction is shown and includes the network polling the user and/or the information supplier for quality control information, as shown in block 702. The network then stores all of the information obtained in a storage device, as shown in block 704. The network then obtains transaction information, as shown in block 706, wherein the transaction information may include, but not be limited to, number of requests, lengths of responsive, quality of response, and/or time required for information retrieval.

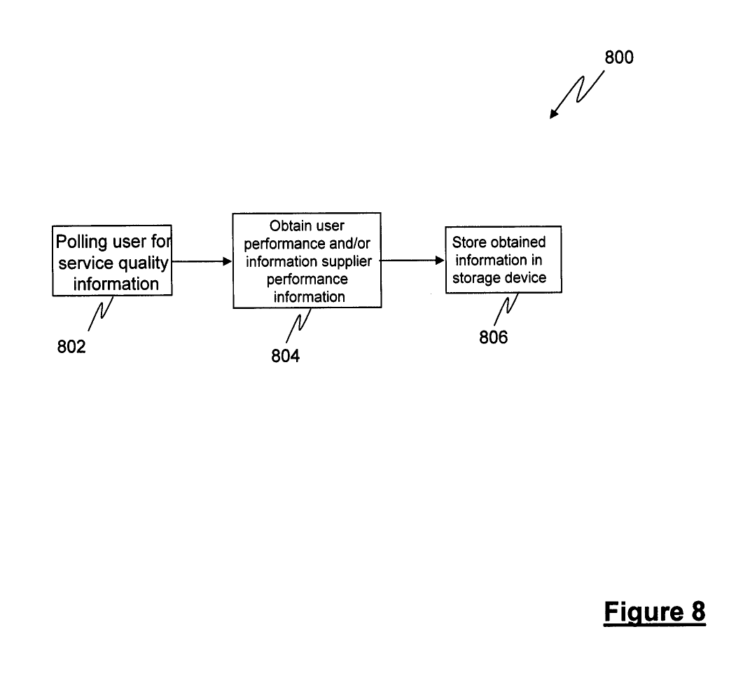

Referring to FIG. 8, a method 800 for obtaining feedback is shown and includes the network polling the user for service quality information, as shown in block 802. The network also obtains at least one of user performance information and information supplier performance information, as shown in block 804. Once the network as obtained all of the required information, the information is stored in a storage device for later retrieval and use, as shown in block 806.

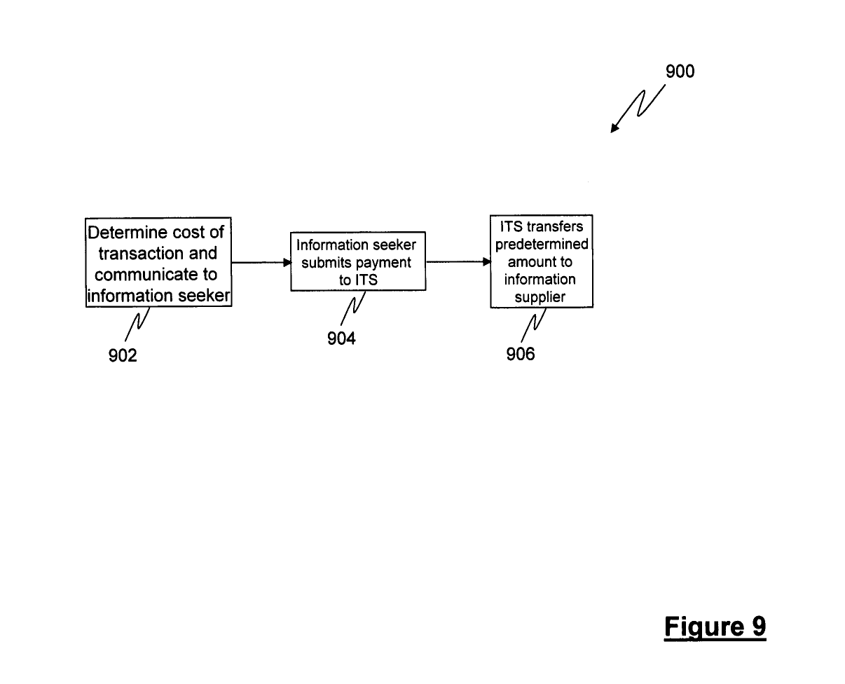

Referring to FIG. 9, a method 900 for processing the information transfer transaction is shown and discussed. Once the transaction has been completed, the network determines the cost for facilitating the transaction and communicates this cost to the user, as shown in block 902. The user submits payment to the network, as shown in block 904, and the network transfers an agreed upon amount to the information supplier, as shown in block 906.

In accordance with an exemplary embodiment, processing of the above method may be implemented through a processing device operating in response to a computer program. In order to perform the prescribed functions and desired processing, as well as the computations therefore (e.g., the execution of fourier analysis algorithm(s), the control processes prescribed herein, and the like), the controller may include, but not be limited to, a processor(s), computer(s), memory, storage, register(s), timing, interrupt(s), communication interfaces, and input/output signal interfaces, as well as combinations comprising at least one of the foregoing. For example, the controller may include signal input signal filtering to enable accurate sampling and conversion or acquisitions of such signals from communications interfaces. It should also be considered within the scope of the invention that the processing of the Figures may be implemented by a controller located remotely from the processing device.

Moreover, in accordance with an exemplary embodiment, the above embodiment(s) can be embodied in the form of computer-implemented processes and apparatuses for practicing those processes. The above can also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Existing systems having reprogrammable storage (e.g., flash memory) can be updated to implement the invention. The above can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to an exemplary embodiment, it will be understood by those skilled in the art that various changes, omissions and/or additions may be made and equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

We claim:

1. A system for implementing a method of transferring information between multiple parties, comprising:
a requester portal;
a supplier portal; and
a contact system, said contact system having a processing device, a routing device and a storage device, wherein said requester portal and said supplier portal are communicated with said contact system and wherein said contact system is configured to implement a method for facilitating an information transfer between multiple parties, wherein said method includes
obtaining characteristic information responsive to an information seeker,
receiving a query from said information seeker,
processing said query from said information seeker to generate an information supplier list responsive to a predetermined algorithm,
associating said information seeker with said one of said information supplier on said information supplier list,
monitoring communications between said information seeker and said information supplier to generate transaction data and
storing said transaction data.

2. The system of claim 1, wherein said requester portal is at least one of a telephone, a computer and a personal digital assistant.

3. The system of clam 1, wherein said supplier portal is at least one of a telephone, a computer and a personal digital assistant.

4. The system of claim 1, wherein at least one of said requester portal and said supplier portal is disposed remotely from said contact system.

5. The system of claim 1, wherein said characteristic information includes at least one of a requester query, financial information, personal information and professional information.

6. The system of claim 1, wherein said query includes at least one request for information.

7. The system of claim 1, wherein said predetermined algorithm is responsive to said information seeker and said information supplier.

8. The system of claim 1, wherein said associating includes communicating said information seeker with said information supplier via said requester portal and said supplier portal.

9. The system of claim 1, wherein said monitoring communications includes monitoring and recording any information exchanged between said information seeker and said information supplier.

10. A method for facilitating the transfer of information between multiple parties, comprising:
obtaining characteristic information responsive to an information seeker;
receiving a query from said information seeker;
processing said query from said information seeker to generate an information supplier list responsive to a predetermined algorithm;
associating said information seeker with said one of said information supplier on said information supplier list;
monitoring communications between said information seeker and said information supplier to generate transaction data; and
storing said transaction data.

11. The method of claim 10, wherein said obtaining includes said information seeker communicating at least a portion of said characteristic information.

12. The method of claim 10, wherein said obtaining includes investigating said information seeker for at least one of financial stability and professional stability.

13. The method of claim 10, wherein said associating includes associating said information seeker with said information supplier responsive to said information seeker.

14. The method of claim 10, wherein said associating includes associating said information seeker with said information supplier via a system for implementing a method of transferring information between multiple parties, wherein said system includes a requester portal, a supplier portal and a contact system.

15. The method of claim 10, wherein said storing includes storing said transaction data in at least one of an analog format and a digital format.

16. The method of claim 10, wherein said storing includes storing said transaction data via at least one of analog, digital and optical.

17. A machine-readable computer program code, the program code including instructions for causing a controller to implement a method for transferring information between multiple parties, the method comprising: obtaining characteristic information responsive to an information seeker; receiving a query from said information seeker; processing said query from said information seeker to generate an information supplier list responsive to a predetermined algorithm; associating said information seeker with said one of said information supplier on said information supplier list; monitoring communications between said information seeker and said information supplier to generate transaction data; and storing said transaction data.

18. The machine-readable computer program code of claim 17, wherein said machine-readable computer program code is encoded onto a storage medium.
